(19) United States
(12) Patent Application Publication
(10) Pub. No.: US 2015/0012344 A1
(43) Pub. Date: Jan. 8, 2015

(54) INTERACTION WITH ADS TO UNLOCK GAME ENHANCEMENTS

(71) Applicant: WMS Gaming, Inc., Waukegan, IL (US)

(72) Inventors: Andrew Guinn, Chicago, IL (US); Richard Robbins, Glenview, IL (US); Jamie Vann, Chicago, IL (US); Rory Shanahan, Chicago, IL (US)

(21) Appl. No.: 14/316,168

(22) Filed: Jun. 26, 2014

Related U.S. Application Data
(60) Provisional application No. 61/842,119, filed on Jul. 2, 2013.

(51) Int. Cl. G06Q 30/02

(52) U.S. Cl. CPC G06Q 30/0209
USPC 705/14.12

(57) ABSTRACT

A computer-implemented method in a gaming system includes displaying an advertisement to a user through one or more display devices. Game-logic circuitry detects user interactions with the advertisement through at least one of the one or more display devices and one or more input devices, and unlocks one or more rewards if the user interactions satisfy one or more engagement requirements.

### CROSS-REFERENCE TO RELATED APPLICATION

This application claims the benefit of U.S. Provisional Application Ser. No. 61/842,119, filed Jul. 2, 2013. The patent application identified above is incorporated here by reference in its entirety to provide continuity of disclosure.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE DISCLOSURE

The present disclosure relates generally to gaming systems and methods and, more particularly, to integrating advertisements with game-based rewards and enhancements.

### BACKGROUND OF THE DISCLOSURE

Electronic gaming services including online contests, sweepstakes, games of chance, wagering games, such as video slots, video poker, and the like, are available for play from various internet-based sites. Increasingly more gaming services are also provided in conjunction with internet-based advertisements to create incentives for participating in a game and to promote an end-product or service. However, conventional advertisements fall short of achieving the desired levels of engagement with target consumers, and are also generally unable to provide the advertising agencies or companies with reliable metrics for determining the effectiveness of their advertisements. Given the widespread use of internet-based advertisements, a need exists to further enhance the promotional value to advertising companies as well as the overall experience of the internet user. More specifically, a need exists for integrating game-based incentives into advertisements to provide more meaningful engagements with consumers and to provide more reliable metrics for assessing the promotional value and effectiveness of the advertisements.

### SUMMARY OF THE DISCLOSURE

According to one aspect of the present disclosure, a computer-implemented method is provided in a gaming system having game-logic circuitry including one or more central processing units and one or more memory devices. The method includes displaying, via at least one of one or more display devices, an advertisement to a user. The game-logic circuitry further detects user interactions with the advertisement through the at least one of one or more display devices and at least one of one or more input devices, and unlocks one or more rewards if the user interactions satisfy one or more engagement requirements.

According to another aspect of the present disclosure, a gaming system, includes one or more gaming servers in communication with one or more clients over one or more networks, each of the one or more gaming servers having game-logic circuitry comprising one or more central processing units and one or more memory devices. The one or more memory devices store instructions that, when executed by the one or more central processing units, cause the at least one of the one or more gaming servers and the one or more clients to display, on at least one of one or more display devices associated with the one or more clients, an advertisement to a user, detect, via at least one of one or more input devices and the at least one of one or more display devices associated with the one or more clients, user interactions with the advertisement, and unlock, by the game-logic circuitry, one or more rewards if the detected user interactions satisfy one or more engagement requirements.

According to yet another aspect of the present disclosure, one or more physical machine-readable storage media include instructions which, when executed by one or more processors, cause the one or more processors to perform operations including displaying an advertisement to a user through one or more display devices, detecting user interactions with the advertisement through at least one of the one or more display devices and one or more input devices, and unlocking, by the one or more processors, one or more rewards if the user interactions satisfy one or more engagement requirements.

Additional aspects of the present disclosure will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a schematic view of a gaming system according to an embodiment of the present disclosure.

FIG. 2 is an image of an exemplary registration page for a gaming service provided through an interface displayed on an output device of a computational device, according to an embodiment of the present disclosure.

FIG. 3 is an image of an exemplary webpage having an advertisement incorporated therein provided through an interface displayed on an output device of a computational device, according to an embodiment of the present disclosure.

FIG. 4 is an image of an exemplary webpage having an advertisement with means for logging into one or more gaming servers incorporated therein, according to an embodiment of the present disclosure.

FIG. 5 is an image of an exemplary webpage having a gaming-enhanced advertisement and a meter for gauging user interactions with the advertisement incorporated therein, according to an embodiment of the present disclosure.

FIG. 6 is an image of an exemplary webpage having a gaming-enhanced advertisement with a gaming session incorporated therein, according to an embodiment of the present disclosure.

FIG. 7 is an image of an exemplary webpage having a gaming-enhanced advertisement with a game enhancement incorporated therein, according to an embodiment of the present disclosure.

FIG. 8 is an image of an exemplary webpage having a gaming-enhanced advertisement with a non-cash reward incorporated therein, according to an embodiment of the present disclosure.

FIG. 9 is an image of an exemplary webpage having a gaming-enhanced advertisement with access to exclusive content incorporated therein, according to an embodiment of the present disclosure.

FIG. 10 is a flowchart of an algorithm that corresponds to instructions executed by one or more processors of a gaming server in accord with at least some aspects of the disclosed concepts.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the appended claims.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts. While the present disclosure may be embodied in many different forms, the embodiments set forth in the present disclosure are to be considered as exemplifications of the principles of the present disclosure and are not intended to be limited to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

Gaming System Overview

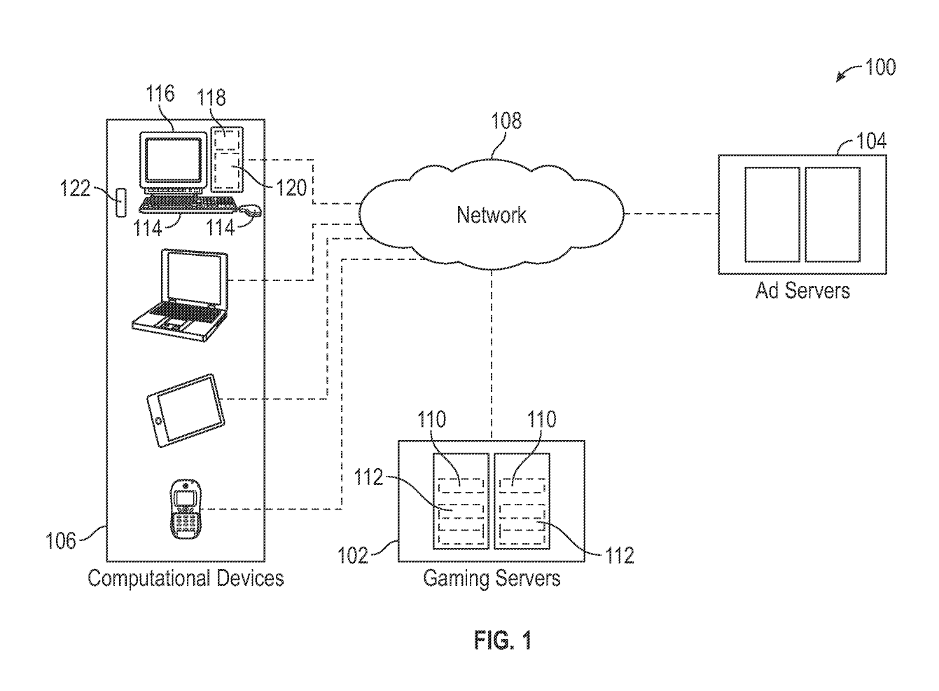

Referring to FIG. 1, one exemplary embodiment of a gaming system 100 is provided. In general, the gaming system 100 may be implemented to manage and/or facilitate certain interactions between gaming service providers, players or participants of games, such as games of chance provided by the gaming service providers, as well as advertising companies. As shown, the gaming system 100 may incorporate one or more gaming servers 102 being operated by gaming service providers, one or more ad servers 104 being operated by advertising companies, one or more computational devices 106 being operated by participating users, as well as one or more networks 108 electronically communicating information between each of the gaming servers 102, ad servers 104 and computational devices 106. The network 108 may take the form of a local area network (LAN), a wireless cellular data network, a wide area network (WAN) such as the internet, or any other suitable network or combination of networks enabling local and/or remote communications between the gaming servers 102, ad servers 104 and the computational devices 106. The network 108 may thereby enable certain gaming sessions, game enhancements, or other game-based incentives or services provided by the gaming servers 102 to be incorporated into certain advertisements provided by the ad servers 104, and further, enable users to access or interact with those gaming-enhanced advertisements using the computational devices 106, as will be discussed in more detail further below.

Gaming Service Providers—Gaming Servers

As shown in FIG. 1, the gaming system 100 may include one or more gaming servers 102 which are managed or operated by gaming service providers, or the like. As is generally held in the art, each gaming server 102 may include at least one processor 110 and at least one memory 112 for storing instructions configured to cause the one or more processors 110 of the gaming server 102 to perform one or more preprogrammed functions or operations. The memory 112 may also be used to retrievably store any databases relevant to one or more of the gaming services provided by the gaming service providers. In general, the gaming servers 102 may enable registered users to participate in any one or more of a variety of gaming services or sessions, such as games of chance, wagering games, contests, sweepstakes, and the like, over the one or more networks 108. Moreover, the gaming servers 102 may be configured to manage and store a plurality of databases including, for example, a database of registered users and respective registration information, a database of instructions for operating gaming sessions or services, and the like.

Furthermore, the gaming servers 102 may manage one or more websites or webpages that are located within the network 108 and operated by gaming service providers to provide gaming services to one or more connected and registered users. More specifically, users may employ any suitable computational device 106 capable of connecting to the network 108 to directly index the webpages that are managed by the gaming servers 102 and participate in one or more gaming sessions as desired. Additionally, the gaming servers 102 may be configured to require users to register or submit relevant user information prior to engaging in any gaming sessions provided by the gaming service providers, thereby restricting access to only authorized, recognized and/or registered users. For new users, for instance, the gaming servers 102 may be configured to request various information from the user using a registration page, or the like, including user identification information, contact information, age verification information, billing information, and the like, and store such information within a database or memory 112 associated therewith. For return users, the gaming servers 102 may only request user-specific credentials, such as logins, passwords and/or any other information sufficient to identify the user from the relevant records stored in memory 112.

In addition to communicating with users through webpages that are managed directly by the gaming service providers, the gaming servers 102 may further interact with users through advertisements that are provided within websites or webpages owned by third-party entities or companies. More specifically, based on certain affiliations between the gaming service providers and the advertising companies, the gaming servers 102 may be configured to retrieve an advertisement from the ad servers 104, and associate game-based incentives with the advertisement prior to displaying the advertisement on a third-party webpage. Moreover, the game-based incentives of the advertisement may be enabled only to users that are registered or have an account with the gaming servers 102 or to users who have opted to enable such features. Furthermore, the gaming servers 102 may deploy clients to be locally installed onto the computational devices 106 of participating users which may aid in enabling and facilitating the game-based functionalities of the incentivized advertisements. For example, the gaming servers 102 may enable the clients to be downloaded onto one or more computational devices 106 through the network 108 in the form of a web browser extension, a toolbar, a plug-in, an add-on, a widget, an application, a program, or the like. Once a client is installed onto a computational device 106 of a user, the gaming servers 102 may be able to communicate any relevant information with the computational device 106 of the user via the client as needed, so as long as the computational device 106 is connected to the network 108 and irrespective of whether the user is accessing a webpage that is directly operated by the gaming servers 102.

Clients—Computational Devices

As depicted in the embodiment of FIG. 1, the computational devices 106 may take any one of a plurality of forms including a mobile device, a cellular phone, a smartphone, a tablet device, a laptop computer, a desktop computer, a device used as a checkout tool, a point-of-sale device or any other suitable device having at least one input device 114 and at least one output device 116. The input device 114 may include any one or more of a mouse, a keypad, a keyboard, a touchpad, a touchscreen, a microphone, a camera, and any other device enabling the participant to input information. The output device 116 may include any one or more of a monitor, a display screen, a touchscreen, a speaker, a dedicated device, such as smart card device with a display, or any other output device enabling a gaming session to be presented to the participant. The computational device 106 may also include one or more processors 118 and at least one memory 120 for storing instructions configured to cause the processor 118 to, among other things, facilitate and/or provide an interface through which a participant may participate in one or more gaming sessions sourced by the gaming servers 102 using the input devices 114 and output devices 116. Correspondingly, the computational device 106 may additionally include at least one communication device 122, such as a modem, a receiver, a transmitter, a transceiver, a network card, an ethernet card, magstripe, or any other communication device having wired and/or wireless connectivity with the gaming servers 102 through the one or more networks 108.

Among other things, a client that is supplied by one or more of the gaming servers 102 may be deployed onto the computational device 106. The client may be initially transmitted over the one or more networks 108 and deployed or installed onto one or more computational devices 106 and integrated in one or more forms of a web browser extension, a toolbar, a plug-in, an add-on, a widget, an application, a program, a dedicated device, such as a smart card device with a display, and the like. Once a client is installed onto a computational device 106, the client may communicate any relevant information between the computational device 106 and the gaming servers 102 to facilitate gaming sessions or services, enable game-based incentives through advertisements, or the like, at the computational device 106. For example, through the client, the gaming servers 102 may configure the processor 118 of the computational device 106 to communicate with the gaming servers 102 to retrieve gaming session data, display gaming session data at the computational device 106, operate a gaming session on the computational device 106, and/or communicate any relevant input submitted by the user and received through the one or more input devices 114 back to the gaming servers 102. The gaming servers 102 may further cause the client and the computational device 106 to communicate with ad servers 104 which may supply the underlying advertisements associated with the gaming services, gaming sessions and/or game-based incentives being supplied by the gaming servers 102. Through the client, the gaming servers 102 may further configure the computational device 106 to detect, monitor and/or gauge relevant actions that a user may submit through the input devices 114, such as interactions with an advertisement, as will be discussed in more detail further below.

Registration Pages

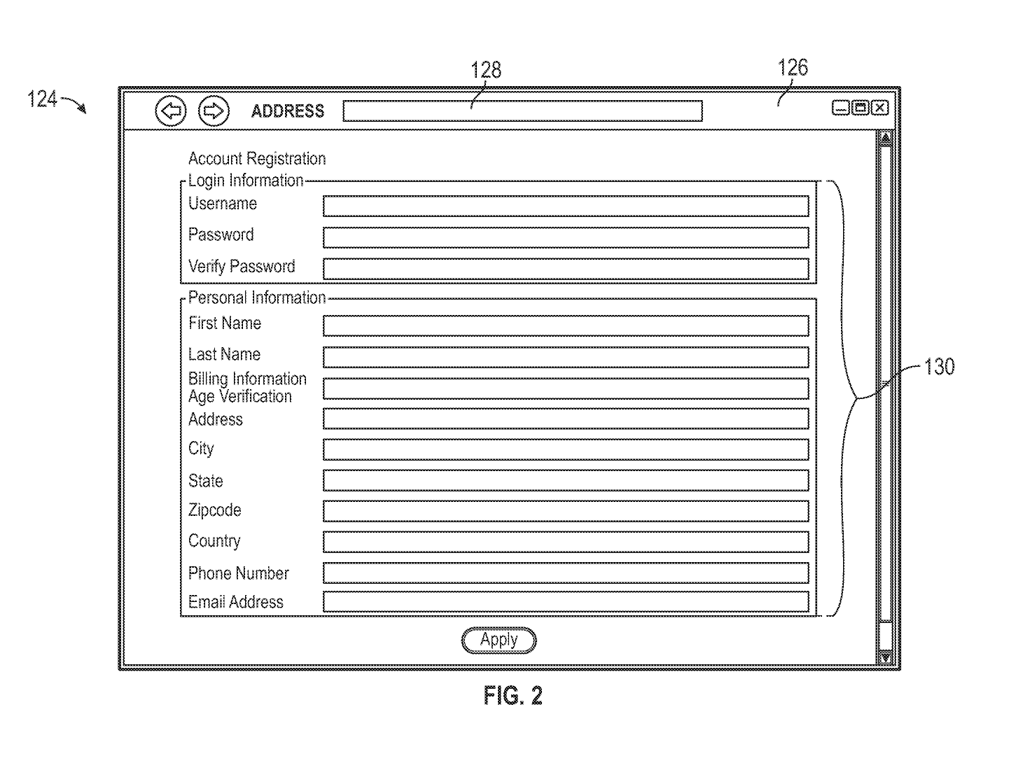

As shown in FIG. 2, a web-based registration page 124 that is affiliated with one or more of the gaming servers 102 is provided. Moreover, the registration page 124 may be provided through a web browser 126 or any other suitable interface that is accessible via one or more of the computational devices 106 having connectivity to the relevant gaming servers 102 over one or more networks 108. A new user may be able to access or navigate to the registration page 124, for example, by selecting a link or hyperlink which directs the user's web browser 126 to the registration page 124, by entering a uniform resource locator (URL) or web address of the particular registration page 124 into an address field 128 of the web browser 126, or by any other means commonly used in the art. While the registration page 124 may take any one of a variety of different forms, the registration page 124 of FIG. 2, for example, may include a plurality of entry fields 130 adapted to receive information that may be required in order to establish a new user account to be associated with the gaming servers 102. The registration page 124 may also serve to collect data sufficient for authorizing user access to any one or more of a variety of content or services associated with the gaming servers 102, ad servers 104, or any combination thereof. In one implementation, the registration page 124 may be employed to gather the user's name, mailing address, contact information, electronic mailing or email address, billing and/or age verification information, as well as any other relevant data pertaining to the new user. In addition, the registration page 124 may also establish an alias, username, login, or any other suitable means of identification by which the gaming servers 102 may be able to identify the user over the one or more networks 108 and easily retrieve the user's account information as needed.

Advertisements—User Recognition

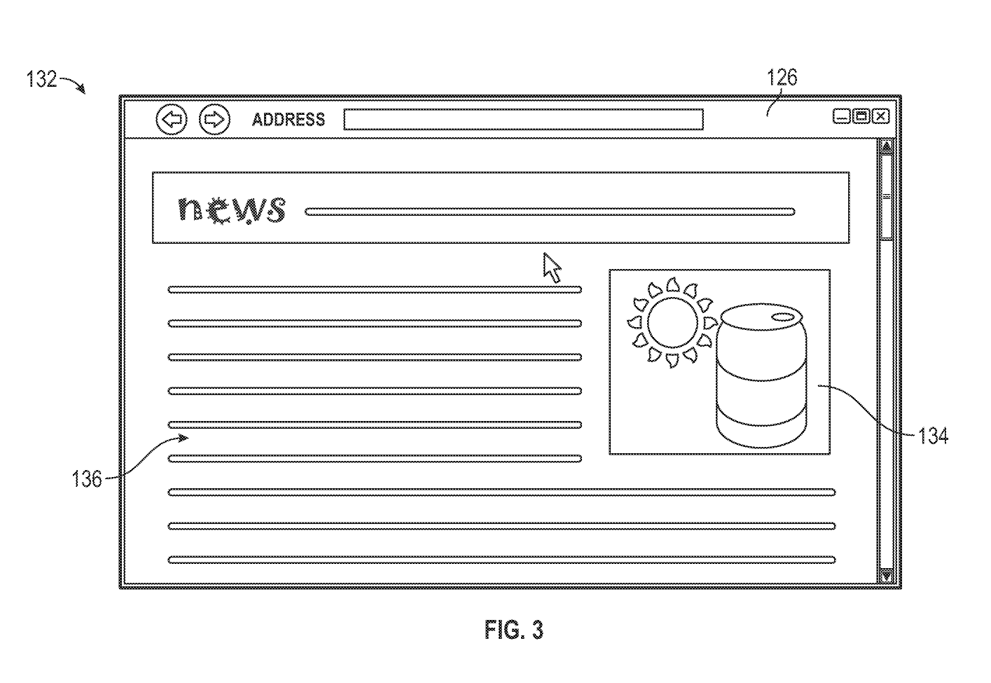

Turning to FIG. 3, a typical webpage 132 that may be hosted by a third-party and accessible by a user at one or more computational devices 106 through a web browser 126 is provided. As shown, the webpage 132 may include therein one or more advertisements 134 that are at least partially sourced by one or more ad servers 104 operated by advertising companies, and/or at least partially sourced by the third-party host, and configured to be visible to the user while the user is viewing third-party content 136. Moreover, in addition to the underlying ad content, the advertisement 134 may further incorporate therein certain content related to the third-party webpage 132, third-party content 136, as well as any other content that may be deemed relevant to the user's interests. Contents of particular interest to the user may be derived, for example, from the user's recent keyword searches, stored cookies, recent social network data, or other browsing history. The user may further be able to change or select the advertisement 134 that is displayed. As with conventional advertisements, the advertisement 134 of FIG. 3 may be configured to include any one or more of a banner, an animation, a video, a game, a newsfeed, a questionnaire, a social application, and the like. The advertisement 134 may also have certain features which may or may not be selectively enabled, such as a floating feature enabling the advertisement to follow the viewing area or be in continuous view of the user regardless of the positioning of the webpage 132 relative to the display or output device 116. In further modifications, the advertisement 134 may include features which enable the advertisement 134 or components thereof to follow the user's viewing area between different webpages, different web browsers 126, different applications, and the like.

Unlike conventional advertisements, however, the advertisement 134 in FIG. 3 may further be associated with one or more gaming servers 102 that are operated by gaming service providers having certain affiliations with the advertising companies supplying the underlying ad content. In particular, the gaming servers 102 may be configured to integrate game-based incentives or services into the advertisement 134, and present such incentives or services to participating users via the advertisement 134 either graphically and/or functionally. Such gaming-enhanced advertisements 134 may wholly replace the conventional or unenhanced counterparts thereof, or may be at least partially superimposed over, integrated into and/or embedded within any existing and unenhanced counterparts thereof. By integrating gaming services or components thereof into the ad content, the gaming-enhanced advertisements 134 may serve to increase the promotional value to the advertising agencies or companies sourcing the underlying ad content, while also improving the overall experience of consumers. The degree to which the advertisements 134 are enhanced by the gaming services may also be modified according to the degree of exposure or promotional value that is desired by the advertising agencies or companies.

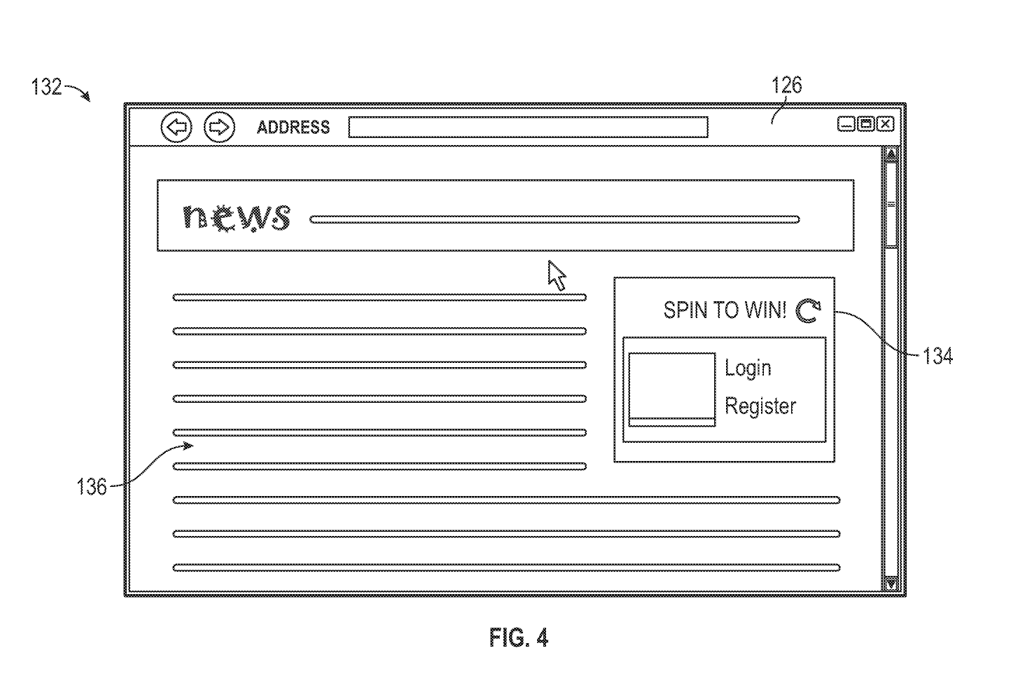

Prior to presenting a user with a gaming-enhanced advertisement 134, the gaming servers 102 may first determine whether a given user is a participating user. While other schemes may exist, the gaming servers 102 may be able to recognize participating users by determining whether the computational device 106 being used to access the webpage 132 has a recognized client, or a client that is specifically associated with the gaming servers 102, installed therein. For example, when the webpage 132 is accessed by a user, the gaming servers 102 may attempt to communicate with a client within the user's computational device 106 to determine if the user is registered or holds an account that is supported by the gaming servers 102, and further, to determine if the user has opted to participate in the gaming services being provided by the gaming servers 102. If no recognized client is found on the user's computational device 106, or if a recognized client is installed, but the user has opted not to participate in the gaming services, the advertisement 134 may be provided unenhanced or without game-based incentives or services implemented therein. If, however, a recognized client is identified and the user has opted to participate in the gaming services, the gaming servers 102 may present the advertisement 134 with game-based incentives or services integrated therein. Additionally or alternatively, the gaming servers 102 may be configured to require the user to login or register prior to accessing any game-based incentives or services associated with the advertisement 134. As shown in FIG. 4, for example, the gaming servers 102 may enable the user to login or register from within the advertisement 134 for the user's convenience. Furthermore, upon successful verification of a user, the user's credentials may be made persistent so as to keep the user logged into any or all of the services that are supported by the gaming servers 102 for a predefined period of time.

Advertisements—User Interaction

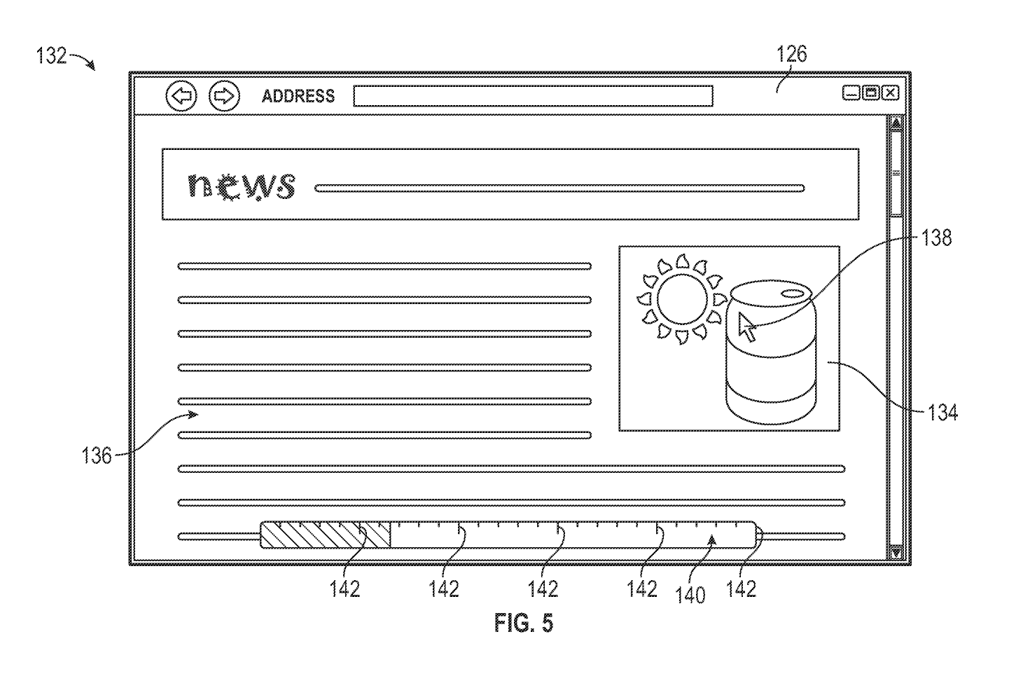

Once a participating or registered user is identified, either by communication with a recognized client or by user login, the ad content underlying the gaming-enhanced advertisement 134 may again be displayed to the user as shown in FIG. 5. Furthermore, the gaming servers 102 may be configured to monitor for any interactions between the user and the presented advertisement 134, and provide the user with one or more game-based rewards based on the type and/or level of user interaction that is detected. More particularly, based on communications with a client that is installed on the user's computational device 106, the gaming servers 102 may be configured to detect for any variety of interactions between the user and the advertisement 134 that may be passively and/or actively conducted using any one or more of the input devices 114 and/or output devices 116 associated with the computational device 106. Passive user interactions may be detected according to the visibility of the advertisement 134 to the user. Based on communications with the client, for example, the gaming servers 102 may detect the user's control of the input devices 114 and/or the data that is output to the user's monitor, display device or any other output device 116, so as to determine the position of the advertisement 134 relative to the viewing area of the output device 116. Active user interactions may be similarly detected based on communications from the client, and may include, for example, mouse-over actions, mouse-click actions, selections or form-fill actions, gameplay actions associated with the advertisement, and the like.

In addition, the gaming servers 102 may be configured to assess detected user interactions relative to one or more predefined engagement requirements for the purposes of qualifying the user for one or more rewards. With regards to passive user interactions, the gaming servers 102 may gauge, for example, the duration of time the advertisement 134 is within a viewing area of the user's display or output device 116, and provide rewards or game enhancements that are proportional in value to the duration of the user interaction. In other configurations, the gaming servers 102 may gauge active user interactions, such as mouse-over actions, based on, for example, the duration of time the user controls an input device 114, such a mouse, or the like, to position a cursor 138 over the advertisement or in proximity thereto as shown in FIG. 5. The gaming servers 102 may additionally be configured to gauge other types of passive user interactions, as well as active user interactions, for example, based on any one or more of mouse-click actions, other selection or form-fill actions, gameplay actions associated with the advertisement 134, or the like. For example, for those advertisements 134 having floating features which may be selectively enabled or disabled by the user, the gaming servers 102 may reward the user certain game enhancements for enabling the floating or following feature. In other modifications, different advertisements 134 may possess different engagement requirements, different reward payouts, different incentives or game-enhancing properties, and the like, that may be determined based in part on the preferences or requests by the respective advertising agencies or companies. The user may further be given options to change or select the specific advertisement 134 that is displayed according to the desired reward payout, the desired game enhancement or incentive, or simply according to personal preference.

Optionally or additionally, the gaming servers 102, in conjunction with the client locally installed on the user's computational device 106, may be configured to display a meter 140, as shown for example in FIG. 5, that is filled according to the gauged user interactions. More specifically, the meter 140 may be time-based, or filled based on the duration of time that the advertisement 134 is within substantial view of the user or within the viewing area of the display or output device 116 of the user. For example, the meter 140 may fill one predefined increment for every second that at least 90% of the advertisement 134 is within the viewing area of the user's monitor 116. The meter 140 may alternatively be filled based on any one or more of a variety of other criteria or in accordance with the specific engagement requirements associated with the given advertisement 134. For example, the meter 140 may be adapted to fill in predefined increments based on the number of or frequency of certain actions that are performed by the user in association with the advertisement 134, such as clicking on the advertisement 134, interacting with game or other media provided within the advertisement 134, and the like.

Additionally, the meter 140 may fill at different increments corresponding to the level of involvement associated with the type of user interaction that is detected. For instance, a mouse-over action, or positioning the cursor 138 over the advertisement 134 may fill the meter 140 in an increment that is less than that of clicking within or on the advertisement 134. Similarly, the meter 140 may also be filled at a rate that varies according to the type of user interaction that is detected, the level of involvement associated with the user interaction, the type of advertisement 134 that is displayed, the type of engagement requirements that are associated with the advertisement 134, or the like. Moreover, the engagement requirements for a particular advertisement 134 or the criteria for filling the meter 140 may vary based on the type of advertisement 134 being used, the type of game-based incentive, enhancement, reward or service that is offered, or according to the type of user interaction that is desired by the associated advertising companies that are supplying the underlying ad content. Furthermore, while the meter 140 may be illustrated as substantially rectangular, opaque and horizontally disposed toward the bottom of the web browser 126, it will be understood that other variations of the meter 140, such as dials, gauges, and the like, as well as other combinations of orientation, size, position, shape, and opacity will be apparent to those skilled in the art. Additionally, while the meter 140 may be configured to be static relative to the viewing area of the user, the meter 140 may also be repositioned, resized or removed by the user as desired.

Still referring to FIG. 5, the gaming servers 102 may be configured to unlock one or more game-based rewards or enhancements to the user if the detected user interactions satisfy one or more of the engagement requirements for a given advertisement 134. In particular, predefined thresholds corresponding to the engagement requirements may be indicated by markers 142 and displayed to the user, thereby enabling the user to monitor progress in achieving the rewards or game enhancements. As shown in FIG. 5, for instance, the meter 140 may be provided with a plurality of markers 142 where each marker 142 may be indicative of a corresponding achievement and/or reward, or alternatively, the meter 140 may be provided with a single marker 142 corresponding to the sole reward offered by the advertisement campaign. The unlockable rewards may include any one or more of a variety of game enhancements that are applicable to one or more gaming sessions provided by the gaming servers 102 and accessible by the user. For example, the unlockable game enhancements may include any one or more of gameplay sessions, credits, points, coins, tokens, social currency, increased odds of winning, contest or sweepstake entries, and the like. The unlockable rewards may alternatively or additionally provide access to exclusive content, such as demos, games, videos, music, programs, applications, or any other content otherwise not readily available to other users within a social network to which the user may be registered. Furthermore, as the gaming servers 102 have already identified the user as a registered user or accountholder, the gaming servers 102 may further be able to link, update or otherwise associate any rewards that have been unlocked by the user with the user's account to be redeemed immediately, within a preset timeframe, or at a later time.

In other modifications, the reward may be configured to be dispensed to one of a plurality of different participating users of a social community, and each qualifying user interaction, whether passive or active, may be configured to progressively increase the value of the reward and/or increase the odds or likelihood of winning the reward. In one example, each qualifying user interaction may at least partially contribute and progressively add to the value of a reward that is triggered by a value-based threshold, or more particularly, a reward that is dispensed when the value of the reward reaches a predefined payout or limit value. Correspondingly, the reward may be dispensed to the user whose contribution triggers the limit value of the reward. In another example, each qualifying user interaction may contribute and progressively add to the value of a reward that is triggered by a time-based threshold, or a reward that is dispensed to the qualifying user whose user interactions satisfies the necessary engagement requirements at the predefined time limit. In other alternatives, for example, involving non-cash prize rewards, each qualifying user interaction may gain the user an additional entry into the drawing for winning the reward, thereby increasing the likelihood of winning the reward. In still further alternatives, each successive, non-winning user interaction may progressively increase the odds or likelihood of winning the payout or reward. Other variations for structuring the accumulation and/or payout of the rewards, game enhancements, exclusive content, non-cash prizes, and the like, will be apparent to those skilled in the art without departing from the scope of the appended claims.

Unlockable Rewards/Game Enhancements

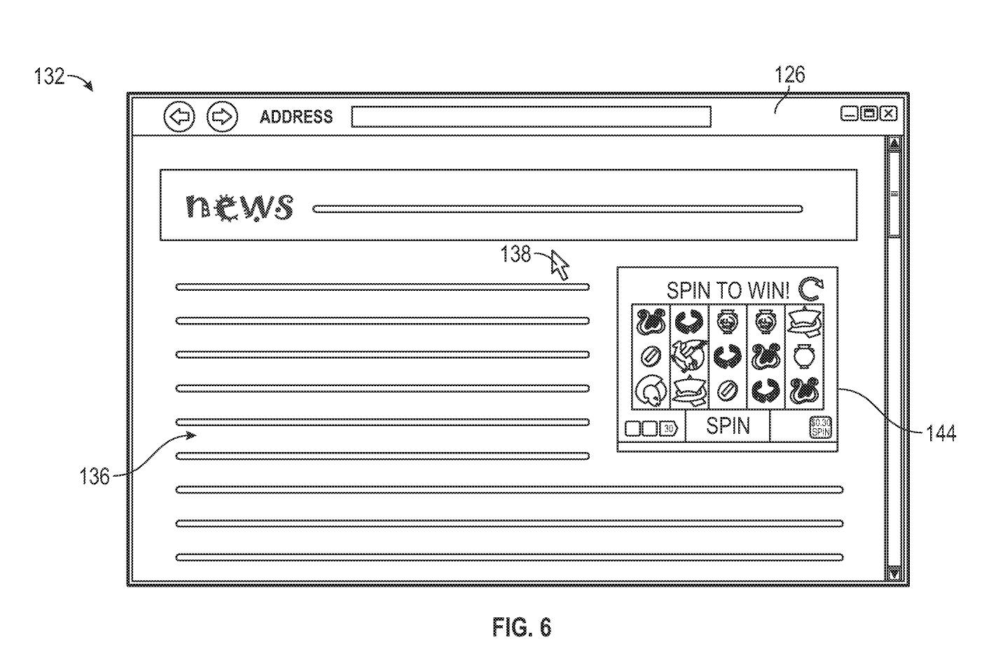

If the engagement requirements for a given advertisement 134 are satisfied, or if, for instance, the meter 140 of FIG. 5 is completely filled, the gaming servers 102 may automatically, or in response to user confirmation, unlock one or more rewards in the form of free gaming sessions, or free gameplay credits for a gaming session. As shown in FIG. 6, for example, a gaming session may be provided within the ad space 144 previously used to display the advertisement 134. Moreover, the gaming sessions may replace the associated advertisement 134, be superimposed over the advertisement 134, or the like. The gaming sessions may include any one or more of slots, reels, poker, blackjack, roulette, keno, bingo, raffles, contests, sweepstakes, word games, social games, or any other games of chance, wagering games and/or games of skill which the user may play using one or more of the input devices 114 and the output devices 116. The gaming sessions may further be adaptive or dynamically generated to incorporate certain content therein that is relevant to the underlying advertisement 134, the third-party content 136, and/or contents of interest to the user, for example, derived in part from the user's recent keyword searches, stored cookies, recent social network data, or other browsing history. For example, a gaming sessions involving a word game may incorporate words that are at least partially related to recent keywords or search queries used by the user. In other alternative configurations, once the appropriate engagement requirements are satisfied, the gaming servers 102 may be configured to automatically, or in response to user confirmation, redirect the user's web browser 126 to another webpage and/or application that is separate from the third-party webpage 132 and operated by the gaming servers 102 to provide the user with one or more gaming sessions. Alternatively, the gaming servers 102 may provide the user with the gaming sessions through a separate web browser 126, or a separate window, pop-up window, tab, or the like, such that the third-party webpage 132 and the third-party content 136 therein are still available to the user. Furthermore, as the gaming servers 102 have already identified the user as a registered user or accountholder, the gaming servers 102 may further link, update or otherwise associate the user's progress and any winnings achieved during the gaming sessions within the ad space 144 with the user's account.

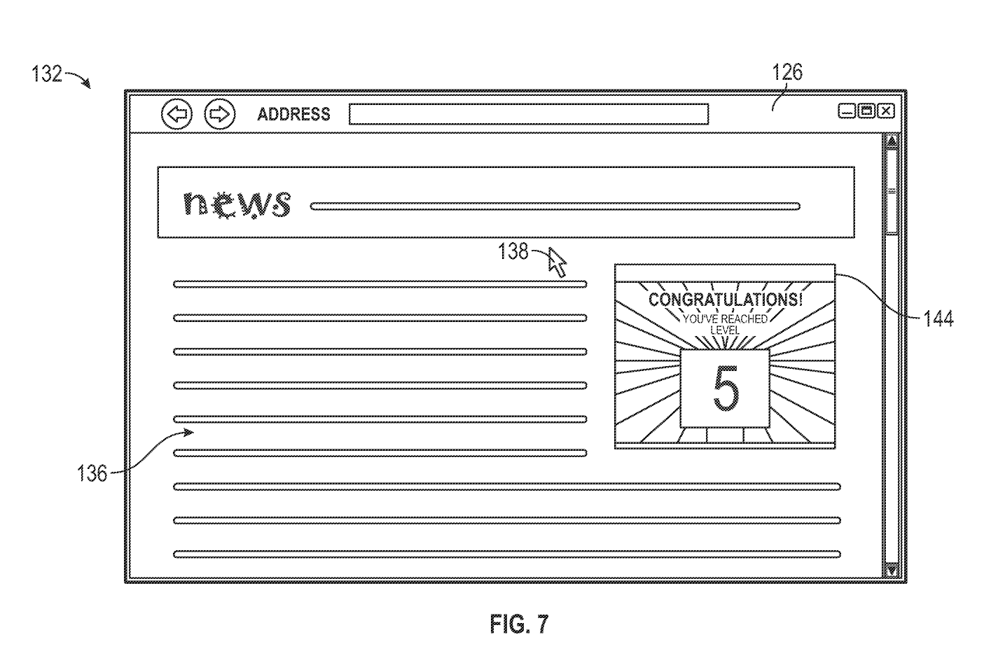

In other alternatives, if the engagement requirements for a given advertisement 134 are satisfied, or if, for instance, the meter 140 of FIG. 5 is completely filled, the gaming servers 102 may automatically, or in response to user confirmation, unlock one or more rewards in the form of game enhancements, as shown for example in FIG. 7. The game enhancements may include any one or more of game credits, points, coins, tokens, level-ups, social currency, increased odds of winning, contest or sweepstake entries, and the like. Moreover, the unlockable game enhancements and incentives may be selected to be applicable to certain gaming sessions that are playable through the gaming services provided by the gaming servers 102. The gaming sessions may include any one or more of slots, reels, poker, blackjack, roulette, keno, bingo, raffles, contests, sweepstakes, word games, social games, or any other games of chance, wagering games and/or games of skill which the user may play using one or more of the input devices 114 and the output devices 116. Furthermore, as the gaming servers 102 have already identified the user as a registered user or accountholder, the game enhancements may be selected based on the type of games or gaming sessions that is of particular interest to the user as determined, for instance, from the user's play history, preferences identified by the user during registration, or the like. As shown in FIG. 7 for example, the gaming servers 102 may unlock a game enhancement in the form of a level-up in a game or gaming session that the user may be in the progress of playing in association with the user's account. Any or all game enhancements that are unlocked by the user may be used or applied immediately, or accumulated in association with the user's account to be redeemed and used at a later time. In further modifications, the gaming servers 102 may provide additional incentives or bonus enhancements to the user if the rewards are redeemed within a preset timeframe.

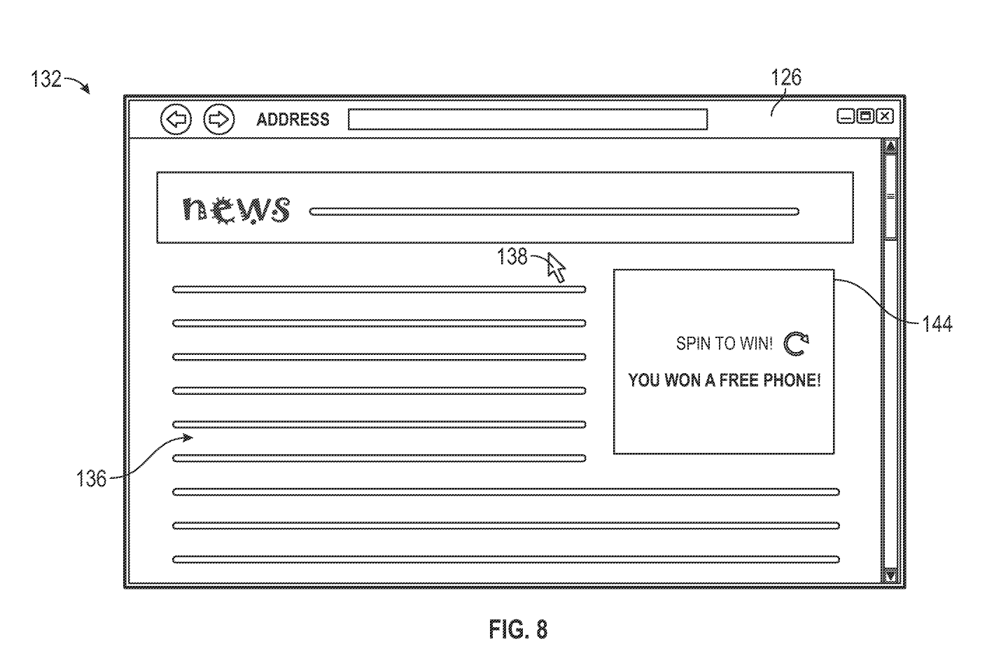

In other modifications, if the engagement requirements for a given advertisement 134 are satisfied, or if, for instance, the meter 140 of FIG. 5 is completely filled, the gaming servers 102 may automatically unlock one or more rewards in the form of non-cash prizes. As shown in FIG. 8, for example, a notification of the unlocked prize may be provided within the ad space 144 previously used to display the advertisement 134. Moreover, the notification may replace the associated advertisement 134, be superimposed over the advertisement 134, or the like. In other alternative configurations, once the appropriate engagement requirements are satisfied, the gaming servers 102 may be configured to automatically redirect the user's web browser 126 to another webpage and/or application that is separate from the third-party webpage 132 and operated by the gaming servers 102 to provide the user with details for receiving the non-cash prize. Alternatively, the gaming servers 102 may provide the user with the non-cash prize notification through a separate web browser 126, or a separate window, pop-up window, tab, or the like, such that the third-party webpage 132 and the third-party content 136 therein are still available to the user. Furthermore, as the gaming servers 102 have already identified the user as a registered user or accountholder, the gaming servers 102 may further update the user's account with information regarding the unlocked prize and/or transmit a notification of the unlocked prize to the user via a text message, an email message, or the like.

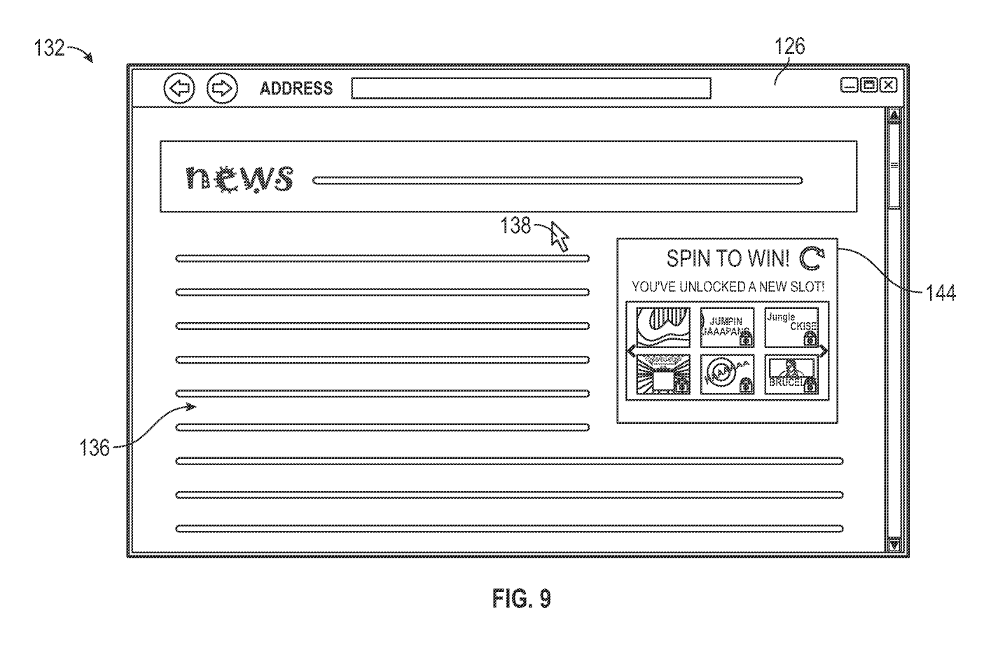

In still further alternatives, if the engagement requirements for a given advertisement 134 are satisfied, or if, for instance, the meter 140 of FIG. 5 is completely filled, the gaming servers 102 may automatically unlock one or more exclusive content for access by the user. For example, the user may be rewarded exclusive access to contents including any one or more of demos, games, videos, music, programs, applications, or any other content otherwise not readily available to other users. As shown in FIG. 9, for example, the user may be offered exclusive access to a new game or a gaming service that has not yet been otherwise released to other users registered with the gaming servers 102. The exclusive content may be made available through the ad space 144 previously used to display the advertisement 134. In other alternative configurations, once the appropriate engagement requirements are satisfied, the gaming servers 102 may be configured to automatically redirect the user's web browser 126 to another webpage and/or application that is separate from the third-party webpage 132 and operated by the gaming servers 102 to provide the user with access to the exclusive content. Alternatively, the gaming servers 102 may provide the exclusive content through a separate web browser 126, or a separate window, pop-up window, tab, or the like, such that the third-party webpage 132 and the third-party content 136 therein are still available to the user. Furthermore, as the gaming servers 102 have already identified the user as a registered user or accountholder, the gaming servers 102 may further update the user's account with the appropriate permissions to enable access to the exclusive content at a later time.

Algorithm/Method

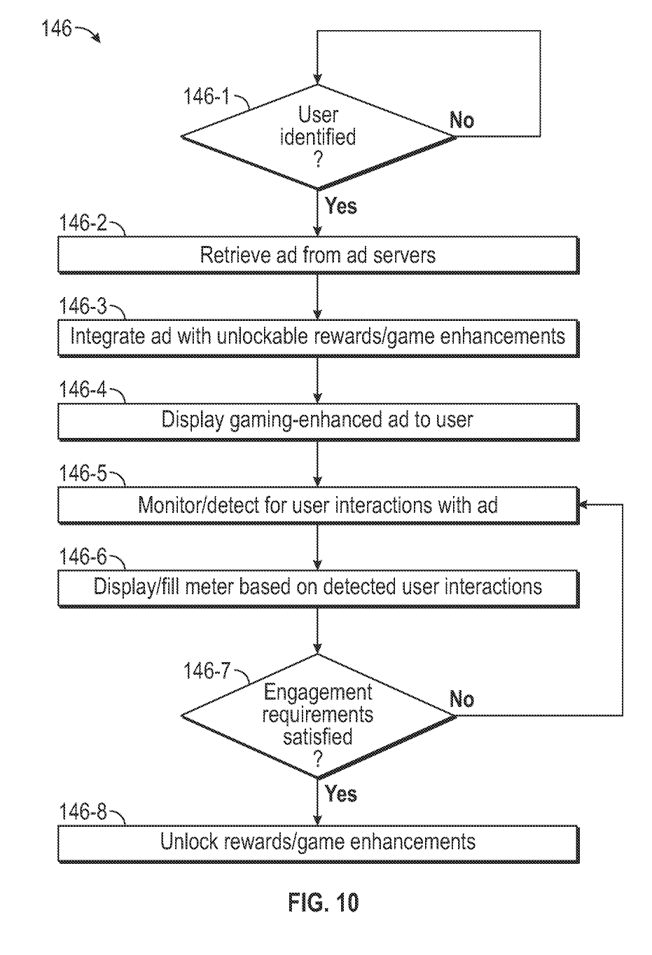

Turning now to FIG. 10, one exemplary embodiment of an algorithm or method 146 is provided, by which one or more of the processors 110 of the gaming servers 102 may be configured to operate, or via a client cause one or more processors 118 of the computational devices 106 to operate, for instance, in conjunction with the gaming system 100 previously discussed. The processors 110, 118 may include any one or more of a controller, a microcontroller, a microprocessor, a central processing unit (CPU), a field programmable gate array (FPGA), a digital signal processor (DSP), or any other suitable means for electronically controlling functionality of the gaming servers 102 and/or the computational devices 106. Instructions for operating the one or more processors 110, 118 of the gaming servers 102 may be provided within a respective memory 112, 120 or other suitable tangible machine-readable storage media, such as a read only memory (ROM), random access memory (RAM), magnetic disk storage media, optical storage media, flash memory, or the like, that is locally or remotely disposed in communication with the respective one of the gaming servers 102 and the computational devices 106.

As shown in step 146-1 of FIG. 10, the processors 110 of the gaming servers 102 may be configured to initially determine if a particular user is an accountholder or registered with at least one of the gaming servers 102. More specifically, the gaming servers 102 may be able to identify a registered user using user-specific credentials, such as a login and a password, and locating the user account having matching credentials from within the relevant databases. The gaming servers 102 may request the user to submit such credentials, for example, using the interface or web browser 126 shown in FIG. 4. If no user account is found, the gaming servers 102 may also enable the user to register, for example, via the registration page 124 shown in FIG. 2. Additionally or alternatively, the gaming servers 102 may be configured to identify a registered user based on communications with a client that is locally installed on the computational device 106 of the user. During step 146-1, the gaming servers 102 may additionally determine whether the user has opted to participate in the relevant gaming services provided by the gaming servers 102 before proceeding further. If the user is successfully identified as an accountholder, and if the user has opted to participate in the relevant gaming services, the gaming servers 102 may be configured to begin retrieving advertisements 134 to be displayed to the user.

Specifically, in step 146-2, the gaming servers 102 may be configured to retrieve one or more advertisements 134 or relevant ad content from one or more of the ad servers 104 over the network 108. Moreover, the gaming servers 102 may be configured to retrieve only those advertisements 134 that have been designated as ad content to be affiliated and/or integrated with one or more of the gaming services provided by the gaming servers 102. In step 146-3, the gaming servers 102 may be configured to integrate gaming-enhanced services, such as unlockable rewards and game enhancements, with the retrieved ad contents or advertisements 134, and in step 146-4, display the gaming-enhanced advertisement 134 to the user. More specifically, the gaming servers 102 may integrate game-based content into the advertisement 134, or superimpose or overlay game-based content onto the advertisement 134. Furthermore, the gaming-enhanced advertisement 134 may be positioned, for example, within the appropriate ad space 144 of a third-party webpage 132, and adapted to be accessible from the user's computational device 106 through a web browser 126, or any other suitable interface. In addition to content related to the underlying advertisement 134, the gaming servers 102 may additionally incorporate content derived in part from the third-party webpage 132 within which the advertisement 134 is initially displayed, or content derived in part from the user's recent keyword searches, stored cookies, recent social network data, or other browsing history.

Additionally, the processors 110 of the gaming servers 102 may be configured to monitor or detect for user interactions between the user and the advertisement 134 in step 146-5. More specifically, the gaming servers 102 may determine whether the user has interacted with the advertisement 134, either passively or actively, to any frequency and/or degree of involvement which satisfies one or more engagement requirements that have been predetermined for the specific advertisement 134. The gaming servers 102 may be able to detect different types of user interactions, for example, via a client that is locally installed on the user's computational device 106 and configured to program the one or more processors 118 thereof to monitor the user's input devices 114 and/or output devices 116 for such user interactions. For example, based on the respective states of the user's input devices 114 and/or output devices 116, the gaming servers 102 may be able to assess the duration of time a particular advertisement 134 is in view or positioned within the viewing area of the user's display or output device 116 to quantify passive user interactions. The gaming servers 102 may also observe the respective states of the user's input devices 114 and/or output devices 116 to detect active user interactions, such as mouse-over actions, or for example, when the user controls a mouse or other input device 114 to position a mouse cursor 138 over the advertisement 134 as shown in FIG. 5.

Optionally or additionally, the gaming servers 102 in step 146-6 may be configured to display a meter 140 which indicates the user's progress in interacting with the advertisement 134, and correspondingly, the user's progress in satisfying the engagement requirements associated with the advertisement 134 and unlocking rewards. As shown in FIG. 5 for example, the meter 140 may provide one or more markers 142 which correspond to the one or more engagement requirements that may be associated with the particular advertisement 134. Moreover, the gaming servers 102 may be configured to fill the meter 140 in predetermined increments and/or at a predefined fill rate that is proportional to the user interactions that are detected during step 146-5. Furthermore, the meter 140 may be filled based on the duration of the user interaction detected, the total number of user interactions, the frequency of the user interactions, the type of user interactions detected, or the like. In addition, the increments by which the meter 140 is filled and/or the rate at which the meter 140 is filled may be varied based on the degree of involvement associated with the user interaction that is detected. For instance, active user interactions may fill the meter 140 in higher increments or at higher fill rates than passive user interactions.

In step 146-7, the gaming servers 102 may be configured to determine whether the detected user interactions satisfy the engagement requirements for a particular advertisement 134. More particularly, the engagement requirements may vary per advertisement 134 and according to the type of exposure or involvement desired by the advertising agency or company supplying the advertisement 134. For certain types of advertisements 134, for example, a single detected instance of user interaction may be sufficient to satisfy the engagement requirements, whereas for other types of advertisements 134, a predetermined minimum number of user interactions must be detected in order to satisfy the engagement requirements. In either configuration, once the engagement requirements for a given advertisement 134 are determined to be satisfied by the gaming servers 102, certain rewards or game enhancements associated with the advertisement 134 may be released or unlocked for the user in step 146-8. As discussed and shown in FIGS. 6-9, for example, the unlockable rewards may include game enhancements, such as gameplay sessions, credits, points, coins, tokens, social currency, increased odds of winning, contest or sweepstake entries, and the like, or alternatively, access to exclusive content, such as demos, games, videos, music, programs, applications, or any other content otherwise not readily available to other users. Upon unlocking such rewards, the gaming servers 102 may further associate the rewards with the user's account to be redeemed immediately, within a preset timeframe, or at a later time.

Each of these embodiments and obvious variations thereof is contemplated as falling within the spirit and scope of the present disclosure as defined and set forth in the following claims. Moreover, the present concepts expressly include any and all combinations and subcombinations of the preceding elements and aspects.

What is claimed is:

1. A computer-implemented method in a gaming system having game-logic circuitry including one or more central processing units and one or more memory devices, the method comprising:
displaying, via at least one of one or more display devices, an advertisement to a user;
detecting, by the game-logic circuitry, user interactions with the advertisement through the at least one of one or more display devices and at least one of one or more input devices; and
unlocking, by the game-logic circuitry, one or more rewards if the user interactions satisfy one or more engagement requirements.

2. The computer-implemented method of claim 1, wherein the advertisement is provided within a webpage accessible to the user and includes any one or more of a banner, an animation, a video, a game, a newsfeed, a questionnaire, and a social application, the advertisement relating to one or more of the webpage, one or more ad servers, and one or more gaming servers with which the user has a user account, the one or more rewards that are unlocked by the user being authenticated through the one or more gaming servers and associated with the user account.

3. The computer-implemented method of claim 1, wherein the user interactions include at least passive user interactions, the passive user interactions being detected based at least partially on a duration of time the advertisement is within a viewing area of the one or more display devices.

4. The computer-implemented method of claim 1, wherein the user interactions include active user interactions, the active user interactions being detected based on any one or more of mouse-over actions, mouse-click actions, selections and form-fill actions, and gameplay actions associated with the advertisement.

5. The computer-implemented method of claim 1, wherein the one or more engagement requirements vary according to a type of the advertisement that is displayed and a type of the one or more rewards that are unlockable.

6. The computer-implemented method of claim 1, further displaying, by the game-logic circuitry, a meter on the at least one of one or more display devices that is filled based on the detected user interactions, the one or more rewards being unlocked when the meter fills to one or more predefined thresholds corresponding to the one or more engagement requirements, the meter being filled at a rate that is varied based on one or more of a type of the advertisement used and a type of the user interaction detected.

7. The computer-implemented method of claim 1, in which the game-logic circuitry further presents, on the at least one of one or more display devices, one or more gaming sessions to the user after the one or more engagement requirements are satisfied, the one or more gaming sessions being dynamically generated to adaptively incorporate content relating to one or more of the advertisement and a webpage within which the advertisement is displayed.

8. The computer-implemented method of claim 1, wherein the one or more rewards include game enhancements that are applicable to one or more gaming sessions, the game enhancements including any one or more of gameplay credits, entries, points, coins, tokens, social currency, and increased odds of winning.

9. The computer-implemented method of claim 1, wherein the one or more rewards provide the user with access to exclusive content otherwise not readily available to other users within a social network to which the user is registered, the exclusive content including any one or more of demos, games, videos, music, programs, and applications.

10. A gaming system, comprising:
one or more gaming servers in communication with one or more clients over one or more networks, each of the one or more gaming servers having game-logic circuitry comprising one or more central processing units and one or more memory devices, the one or more memory devices storing instructions that, when executed by the one or more central processing units, cause the at least one of the one or more gaming servers and the one or more clients to:
display, on at least one of one or more display devices associated with the one or more clients, an advertisement to a user;
detect, via at least one of one or more input devices and the at least one of one or more display devices associated with the one or more clients, user interactions with the advertisement; and
unlock, by the game-logic circuitry, one or more rewards if the detected user interactions satisfy one or more engagement requirements.

11. The gaming system of claim 10, wherein the one or more gaming servers communicate with one or more clients that are integrated onto one or more computational devices using one or more of web browser extensions, toolbars, plug-ins, add-ons, widgets, applications, and programs, and the one or more gaming servers are in communication with one or more ad servers over the one or more networks, the instructions causing the one or more gaming servers to at least partially retrieve the advertisement from the one or more ad servers, display the advertisement within a webpage accessible to the user, and associate the one or more unlocked rewards with an account of the user.

12. The gaming system of claim 11, wherein the advertisement includes any one or more of a banner, an animation, a video, a game, a newsfeed, a questionnaire, and a social application, the advertisement relating to one or more of the webpage, the one or more ad servers, and the one or more gaming servers associated with the user's account.

13. The gaming system of claim 10, wherein the instructions further cause the game-logic circuitry to detect at least one of passive user interactions and active user interactions, the passive user interactions being detected based at least partially on a duration of time the advertisement is within a viewing area of the one or more display devices, and the active user interactions being detected based on any one or more of mouse-over actions, mouse-click actions, selections and form-fill actions, and gameplay actions associated with the advertisement.

14. The gaming system of claim 10, wherein the instructions further cause the game-logic circuitry to quantify the one or more engagement requirements based on a duration of time the advertisement is visible to the user.

15. The gaming system of claim 10, wherein the instructions further cause the game-logic circuitry to unlock the one or more rewards in one or more forms of gameplay credits, entries, points, coins, tokens, social currency, increased odds of winning, and exclusive content.

16. One or more physical machine-readable storage media including instructions which, when executed by one or more processors, cause the one or more processors to perform operations comprising:
displaying an advertisement to a user through one or more display devices;
detecting user interactions with the advertisement through at least one of the one or more display devices and one or more input devices; and
unlocking, by the one or more processors, one or more rewards if the user interactions satisfy one or more engagement requirements.

17. The one or more physical machine-readable storage media of claim 16, wherein the user interactions include at least one of passive user interactions and active user interactions, the passive user interactions being detected based at least partially on a duration of time the advertisement is within a viewing area of the one or more display devices, and the active user interactions being detected based on any one or more of mouse-over actions, mouse-click actions, selections and form-fill actions, and gameplay actions associated with the advertisement.

18. The one or more physical machine-readable storage media of claim 16, wherein the one or more engagement requirements are determined based on a duration of time the advertisement is visible to the user.

19. The one or more physical machine-readable storage media of claim 16, further displaying a meter on the one or more display devices that is filled based on the detected user interactions, the one or more rewards being unlocked when the meter fills to one or more predefined thresholds corresponding to the one or more engagement requirements, the meter being filled at a rate that is varied based on one or more of a type of the advertisement used and a type of the user interaction detected.

20. The one or more physical machine-readable storage media of claim 16, wherein the one or more rewards include one or more of game enhancements and exclusive content, the game enhancements being applicable to one or more gaming sessions and including any one or more of gameplay credits, entries, points, coins, tokens, social currency, and increased odds of winning, the exclusive content including any one or more of demos, games, videos, music, programs, and applications otherwise not readily available to other users within a social network to which the user is registered.
